(19) United States
(12) Patent Application Publication
(10) Pub. No.: US 2006/0010423 A1
(43) Pub. Date: Jan. 12, 2006

(54) Variable namespaces and scoping for variables in an object model

(75) Inventor: J. Kirk Haselden, Sammamish, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/887,273

(22) Filed: Jul. 8, 2004

(51) Int. Cl. G06F 9/44

(52) U.S. Cl. 717/116

(57) ABSTRACT

Providing for the utilization of namespaces in connection with an object model variable enables variables to be differentiated by associating each variable with one of a number of available namespaces. Related variables can be grouped together by associating a group of variables with a particular namespace, thereby making it easier to recognize related variables. Providing scoping capabilities for a variable is enabled by associating a variable with the object that created it and making that variable inaccessible to another object within the execution environment.

### FIELD OF THE INVENTION

This application is related to Attorney Docket No. MSFT-3521, “PROVIDING INFORMATION TO AN ISOLATED HOSTED OBJECT VIA SYSTEM-CREATED VARIABLE OBJECTS”, filed herewith.

### FIELD OF THE INVENTION

The invention relates to object models and in particular to using namespace variables and scoping of variables within the context of object models.

### BACKGROUND OF THE INVENTION

In general, a variable name within an object model must be unique so that there is no ambiguity within a set of names. It would be helpful, however, to be able to disambiguate variables within an object model having different origins but the same name. Likewise, it would be helpful to be able to group related variables together so that the variables are instantly recognizable as belonging to the same group.

In general, in an object model, variables used within an object such as a container or other subsection of an object model are accessible to other objects in the model. Sometimes, however, it would be helpful to restrict the accessibility of a variable to a particular container within the object model.

### SUMMARY OF THE INVENTION

Providing for the utilization of namespaces in connection with an object model variable enables variables to be differentiated by associating each variable with one of a number of available namespaces. Related variables can be grouped together by associating a group of variables with a particular namespace, thereby making it easier to recognize related variables.

Providing scoping capabilities for a variable is enabled by associating a variable with the object that created it and making that variable inaccessible to another object within the execution environment. This may increase the safety of the variable because only the object that created the variable may read or modify the value of the created variable. Third-party developers may find this feature particularly useful because plug-in components may require their variable values to be protected from external manipulation.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of an exemplary system for providing information to isolated objects and/or providing namespace differentiation for variables in an object model and/or for providing scope for variables in an object model in accordance with one embodiment of the invention;

FIG. 3 is a block diagram of an exemplary implementation of the system of FIG. 2 in accordance with one embodiment of the invention;

FIG. 4 is a flow diagram of an exemplary method of providing information to an isolated hosted object via a system-created variable in accordance with one embodiment of the invention; and

FIG. 5 is a block diagram of an exemplary system for providing namespace differentiation for variables in an object model in accordance with one embodiment of the invention;

FIG. 6a is an exemplary display of variables differentiated by namespace in an object model in accordance with one embodiment of the invention;

FIG. 6b is a flow diagram of an exemplary method for differentiating variables in an object model by namespace in accordance with one embodiment of the invention;

FIG. 7 is an exemplary display of scoping of variables in accordance with one embodiment of the invention;

FIG. 8 is a block diagram of a system for scoping variables in an object model in accordance with one embodiment of the invention; and

FIG. 9 is a flow diagram of an exemplary method for scoping variables in an object model in accordance with one embodiment of the invention.

### DETAILED DESCRIPTION OF ILLUSTRATIVE EMBODIMENTS

Overview

An object model may be defined as a collection of objects and relationships. Each of the objects may be associated with one or more properties that govern the execution behavior of the object.

In an illustrative implementation, a Data Transformation Service (DTS) provides a set of tools that allows for the extraction, transformation/consolidation and loading of data from one or more sources into one or more destinations supported by DTS connectivity. By using DTS tools to graphically build DTS packages or by programming a package with the DTS object code, custom data movement solutions tailored to the specialized business needs of an organization may be created.

A DTS package is an organized collection of connections, DTS tasks, DTS transformations and workflow constraints assembled either programmatically or with a DTS tool and saved to MICROSOFT® SQL Server™, a structured storage file, an XML file or a Microsoft Visual Basic® file. Generally, each package includes one or more steps that are executed sequentially or in parallel when the package is run. When executed, the package connects to the appropriate data source(s), extracts data from the source(s), (optionally) transforms the data, and loads the transformed data into one or more destinations.

A DTS task is a discrete set of functionality, executed as a step in a DTS package. Each task defines a work item to be performed as part of the data movement and data transformation process, or as a job to be executed. Examples of commonly used DTS tasks include importing and exporting data, transforming data, copying database objects, and sending messages to and receiving messages from other users and packages, and so on. A DTS transformation may include one or more functions or operations applied to a piece of data before the data is loaded into the destination. A DTS transformation may be composed of a number of DTS sub-transformations, connected together into a transformation chain; that is, the output of a first sub-transformation may be input to the next sub-transformation in the chain and so on.

A DTS package may be associated with one or more variables, which may be implemented as objects. A variable object in a package may be used in a way similar to the way a variable is used in a traditional programming language, that is, a DTS variable object may be created, its value may be changed or updated, the variable may be associated with a particular type (e.g., read-only, temporary, etc.) and so on.

In the DTS object model, an object may be wrapped by a host object that isolates the object from the rest of the object model. Often the hosted object needs access to the properties of other objects in the object model, but because of the benefits of isolation, it is not desirable to permit the object access to the other objects directly.

System variables are variable objects created by the DTS runtime, (the execution environment that handles the execution time behavior of the DTS object model), to expose certain critical properties of the object model to an isolated hosted object. The collection of system variables is accessible by the hosted object, and may be identified by using a specified naming convention. In this way, the hosted object has access to required or useful system information, yet the hosted object remains isolated.

A variable created by an object within the object model may be associated with a namespace. Variables having the same namespace need not have originated from the same object. Hence, a group of related variables can be readily identified by associating the group of related variables with one namespace. Similarly, two variables with the same name (e.g., created by two different objects within the object model) can be distinguished from one another by associating one of the variables with one namespace (perhaps indicative of the source of the variable) and the other variable with a second namespace.

A variable can be hidden or made inaccessible to other parts of an object model by scoping a variable to a subsection of an object model.

Exemplary Computing Environment

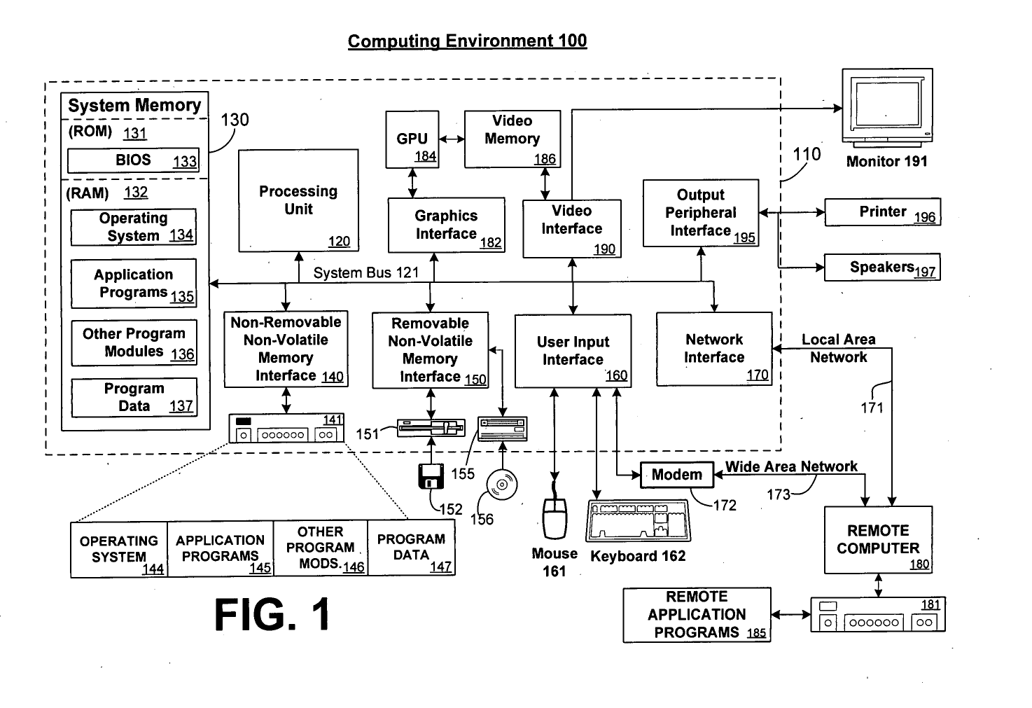

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to. the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Providing Information To An Isolated Hosted Object Via System-Created Variables

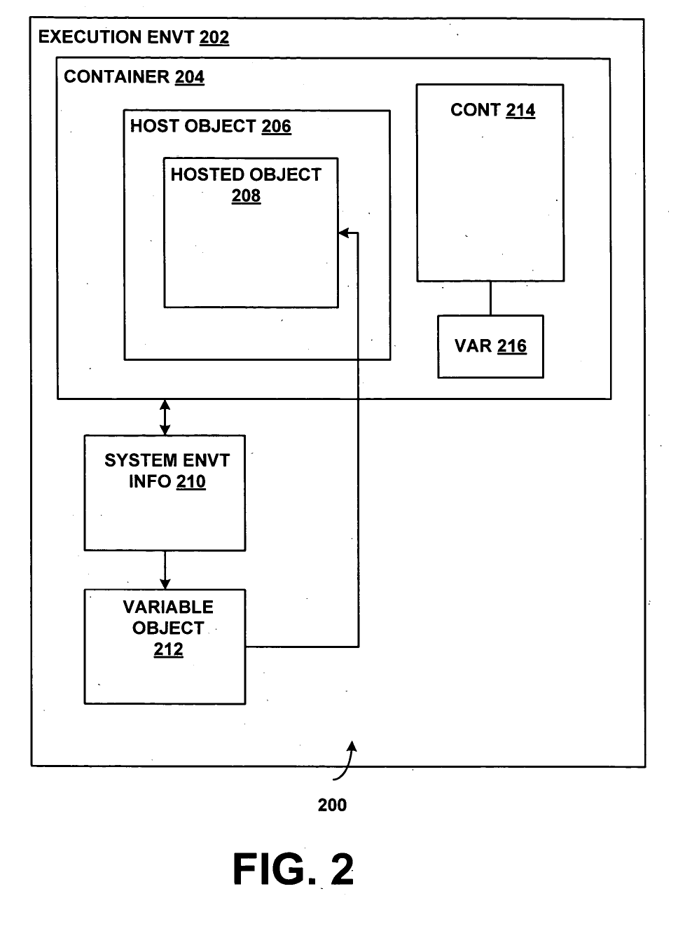

FIG. 2 is a block diagram of an exemplary system 200 for providing information to an isolated hosted object via one or more system-created variable objects in accordance with one embodiment of the invention. Alternatively, or in addition, exemplary system 200 may provide variable namespace information and/or may provide variable scope in an object model. The system of FIG. 2 may reside on a computer such as computer 110 described above with respect to FIG. 1. Alternatively, system 200 may be distributed across one or more computers.

In FIG. 2, system 200 may comprise one or more of the following: an execution environment 202, one or more containers, as represented by containers 204 and 214, container-specific variables associated with a container, represented by variables 216, one or more host objects as represented by host object 206, and one or more hosted objects as represented by hosted object 208. A container such as container 204 may be included within another container, (not shown). Similarly, container 204 may include another container, (not shown). Any number of levels of nesting of containers are possible. A container such as container 204 may be associated with one or more properties or other system environment information points such as counters, enumerators, environment variables, execution parameters and so on as represented by system environment information 210 in FIG. 2. The collection of all the objects of system 200 may be referred to as the object model for system 200. In FIG. 2, the object model includes container 204, host object 206, hosted object 208, system environment information 210, variable object 212.

An execution environment (e.g., a runtime) may execute container 204. Container 204 may include one or more host objects such as host object 206. A host object may wrap a hosted object and expose properties of the hosted object and other properties and behavior. Host object 206 may host one or more hosted objects such as hosted object 208.

Hosted object 208 in some embodiments of the invention may be an isolated object, that is, hosted object 208 may execute within the environment of host object 206 and be unaware of container 204 or anything external to host object 206. In other words, hosted object 208 may be wrapped by a host (e.g., host object 206) that isolates hosted object 208 from the rest of the object model. In some embodiments of the invention, the hosted object 208 may be extensible. An object type that may be extended, modified, replaced or created by a third party may be considered an extensible object. Exemplary extensible objects include but are not limited to a new object type that “plugs in” to an existing object model and an object type from which a new object type may be derived.

Container 204 may be associated with one or more properties or other information about the environment such as counters, enumerators, environment variables, execution parameters or the like, represented in FIG. 2 by exemplary system environment information 210. System environment information 210 in some embodiments of the invention is directly inaccessible to hosted object 208. In some embodiments of the invention, one or more variable objects, represented in FIG. 2 by exemplary variable object 212 are created to store the value of system environment information 210. Variable object 212 may be directly accessible to hosted object 208.

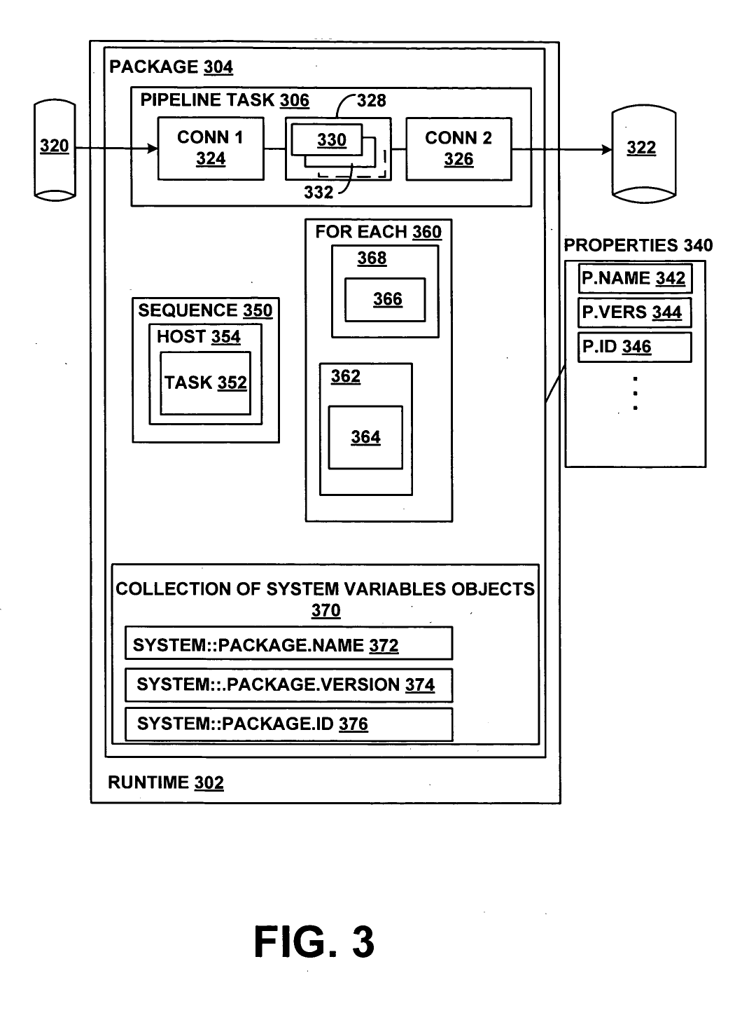

FIG. 3 illustrates an exemplary implementation of a system for providing information to an isolated hosted object via one or more system-created variable objects. In FIG. 3, package 304 is a DTS package as described above for extracting data from a source 320, optionally transforming the data and loading the data into a destination 322. Package 304 may be executed by execution environment 302. In some embodiments of the invention, execution environment 302 is Microsoft's DTS runtime. Source 320 may comprise a structured file (including but not limited to an HTTP file, an HTML document/file, an XML document/file), an unstructured file (including but not limited to a flat file, or FTP (File Transport Protocol) file), a semi-structured file, or a database (such as but not limited to a SQL database, Oracle database, or the like) from which data is to be extracted. Destination 322 may comprise a structured file (including but not limited to an HTTP file, an HTML document/file, an XML document/file), an unstructured file (including but not limited to a flat file, or FTP (File Transport Protocol) file), a semi-structured file, or a database (such as but not limited to a SQL database, Oracle database or the like) into which data is to be loaded.

A DTS package such as DTS package 304 may be associated with one or more properties (e.g., PackageName, PackageVersion, PackageID, etc.) or other system environment information including counters, enumerators, environment variables, execution parameters or the like. The collection of properties and other system environment information is represented in FIG. 3 as package properties 340, a collection of properties and other system environment information including PackageName 342, PackageVersion 344, PackageID 346, etc. In some embodiments of the invention, runtime 302 creates a collection of variable objects for storing the values for the collection of properties and other system environment information. In FIG. 3, this collection of variable objects is represented as system variables 370, and includes system variable objects System::PackageName 372, System::PackageVersion 374, System::PackageID 376, etc. corresponding respectively to PackageName 342, PackageVersion 344, PackagelD 346, etc. That is, for example, System::Package.Name 372 may be the system-created object corresponding to Package.Name 342 and so on. Runtime 302 may update the collection of system variable objects 370 as the values of the package properties 340 change.

An exemplary DTS package 304 in FIG. 3 may include a pipeline task. A pipeline task such as exemplary pipeline task 306 references connection managers 324 and 326 and transformations 328. Connection managers, as represented by connection managers 324 and 326 in FIG. 2, may in some embodiments, enable connections to be made to a source or destination. For example, connection manager 324 may manage the connection between the DTS package 304 and the source 320 while connection manager 326 may manage the connection between the DTS package 304 and the destination 322.

Data extracted from source 320 may be transformed as determined by transformations 328. Transformations 328 may be composed of one or more steps in a transformation chain, as represented by sub-transformations 330, 332, etc. in FIG. 3.

A DTS package such as DTS package 304 may include one or more hosted objects, representing functionality within the DTS package. DTS hosted objects may be tasks, connection managers, (also called connections), log providers and so on. Hosted objects may be hosted by respective host objects such as ConnectionHost, TaskHost, LogProviderHost and so on.

DTS package 304 may include a number of hosted objects, such as exemplary hosted objects 352, 364 and 366 hosted respectively by host objects 354, 362 and 368 in FIG. 3. These hosted objects may be tasks, connections, log providers and so on. Exemplary host objects may include but are not limited to a task host, a connection host, a log provider host and so on. Exemplary tasks include but are not limited to FTP tasks, SQL tasks, file system tasks and the like. Hosted objects such as tasks, connections, log providers and so on may be included within containers such as a sequence (e.g., sequence 350) or a for each loop (e.g., for each loop 360) or the like. Hosted objects, as discussed above, do not have direct access to properties and other environment information associated with the DTS package (e.g., collection of properties 340). Suppose, for example, that DTS package 304 includes an isolated hosted object (e.g., a task 352). Suppose further that task 352 needs to know the value of the PackageVersion property 344 for package 304. Task 352, because it is an isolated hosted object within host object 354, does not have direct access to property PackageVersion property 344, however, task 352 does have direct access to system variables object collection 370 and may access System.Package.Version property 374 of system variables objects collection 370 to obtain this information.

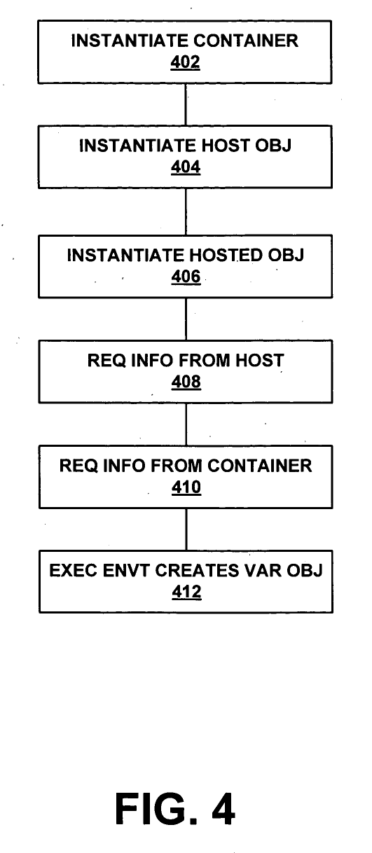

FIG. 4 is a flow diagram for a method of providing information to an isolated hosted object in an object model via a system-created variable object. One or more of the steps in the method may be optional. One or more of the steps in the method may be repeated. In some embodiments of the invention, the steps may occur in any order. At step 402 a container may be instantiated by an execution environment. At step 404 the container may instantiate a host object. At step 406 the host object may instantiate a hosted object. At step 408 the hosted object may require information from the object model and request the required information from the host object. At step 410 the host may ask the container for the required information. At step 412, in response to receiving the request for the required information from the container, the execution environment may place the requested information in an object accessible to the hosted object (e.g., in the collection of objects called system variable objects.) The hosted object may retrieve the required information from the collection of system variable objects. The execution environment may update the system variable objects as the value of the corresponding hosted object-inaccessible information changes.

For example, referring again to FIG. 3, suppose a host object 362 hosts a hosted object 364. Suppose hosted object 364 is a logging task within a container 360. Logging task 364 may require the Package.Version property 344 of DTS package 304 in order to place this information on the log. However, logging task 364 may be unable to directly access Package.Version 344. Logging task 364 may request Package.Version from task host 362 (step 408 in FIG. 4). The task host 362 may request this information from FOR EACH loop 360, (step 410) which may request Package.Version from DTS package 304 (step 410) which requests this information from the runtime 302. Runtime 302 (step 412) may place the value of Package.Version 344 in system-created variable object System.Package.Version 374. Logging task 364 may then access System. Package.Version.

Variable Namespaces

A namespace in accordance with some embodiments of the invention, enables the complexity of a software system to be hidden by allowing variables on objects to be differentiated and/or grouped together by associating one variable or a group of variables with a particular namespace. In some embodiments of the invention, a variable namespace is implemented as an extra name on a variable that identifies the variable as part of a group or as associated with a particular task.

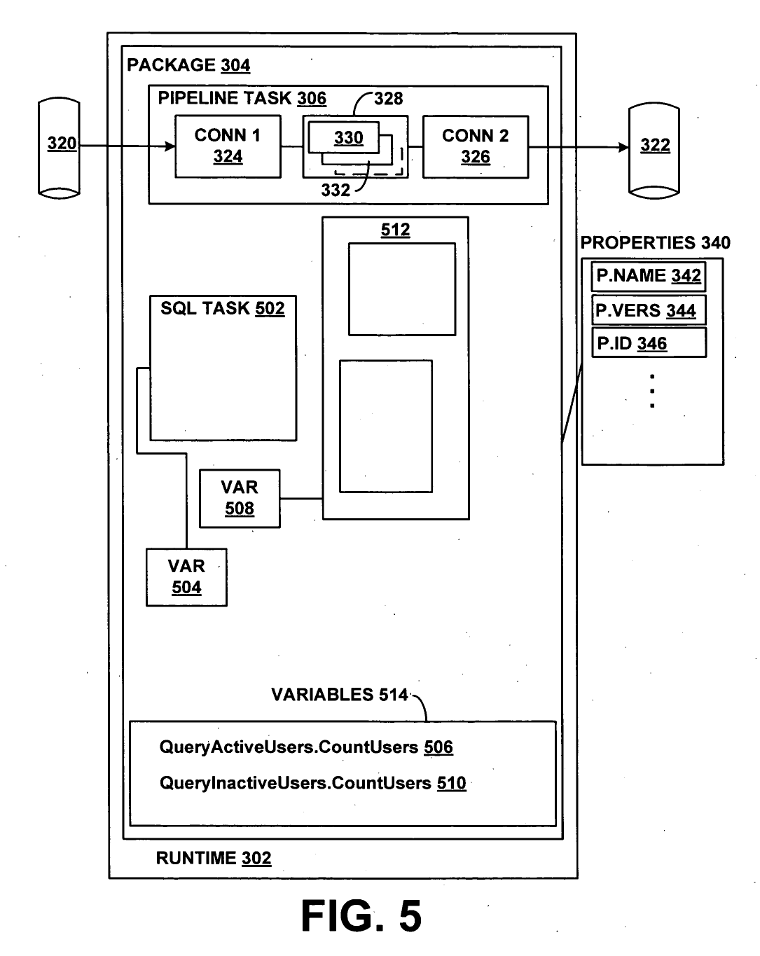

FIG. 5 illustrates an exemplary implementation of the system of FIG. 2 for differentiating variables in accordance with some embodiments of the invention. In FIG. 5, package 304 is a DTS package as described above for extracting data from a source 320, optionally transforming the data and loading the data into a destination 322. Package 304 may be executed by execution environment 302. In some embodiments of the invention, execution environment 302 is Microsoft's DTS runtime. Source 320 may comprise a structured file (including but not limited to an HTTP file, an HTML document/file, an XML document/file), an unstructured file (including but not limited to a flat file, or FTP (File Transport Protocol) file), a semi-structured file, or a database (such as but not limited to a SQL database, Oracle database, or the like) from which data is to be extracted. Destination 322 may comprise a structured file (including but not limited to an HTTP file, an HTML document/file, an XML document/file), an unstructured file (including but not limited to a flat file, or FTP (File Transport Protocol) file), a semi-structured file, or a database (such as but not limited to a SQL database, Oracle database or the like) into which data is to be loaded.

An exemplary DTS package 304 in FIG. 3 may include pipeline task 306. Pipeline task 306 references connection managers 324 and 326 and transformations 328. Connection managers, as represented by connection managers 324 and 326 in FIG. 5, may in some embodiments, enable connections to be made to a source or destination. For example, connection manager 324 may manage the connection between the DTS package 304 and the source 320 while connection manager 326 may manage the connection between the DTS package 304 and the destination 322.

Data extracted from source 320 may be transformed as determined by transformations 328. Transformations 328 may be composed of one or more steps in a transformation chain, as represented by sub-transformations 330, 332, etc. in FIG. 3.

Package 304 may include one or more containers or components represented by SQL task 502 and container 512 in FIG. 5. SQL Task 502 may be associated with one or more variables such as variables 504 and container 512 may be associated with variables such as variables 508. Suppose the SQL task 502 is named “QueryActiveUsers”. Variable 504 in FIG. 5 may represent, for example, a variable associated with SQL task 502. Suppose the value stored in variable 504 is a count of active users. Calling variable 504 by a name that reflects its use and associating the variable with a namespace associated with the component that uses it, may assist in the use of the component and in the use of the package in which the component is used because it may be easier to identify which variables are being used by which components. In some embodiments of the invention, the convention used therefor is Namespace: :VariableName. For example, variable 504 may be referred to as QueryActiveUsers::CountUsers, the name identifying both the component that uses the variable (“QueryActiveUsers”) and what the variable is used for (“CountUsers”). That is, in other words, the variable named “CountUsers” is associated with the namespace “QueryActiveUsers”. Similarly, a number of variables all associated with the QueryActiveUsers component may all be associated with the namespace “QueryActiveUsers”.

The double colon (“::”) here serves as a token to identify the end of the namespace identifier and the beginning of the variable name. It will be apparent that any suitable namespace and variable names may be used and any token character or group of characters may be selected to distinguish between namespace and variable name. The namespace differentiated variable(s) may be stored in a variables area 514. In some embodiments of the invention, the namespace differentiated variables are stored in a separate variables area than other object model variables.

As the number of components in a package increases, the value of this feature may increase. For example, identical variables names used with different components may be disambiguated. For example, suppose another component “QueryInactiveUsers”, represented in FIG. 5 by container 512, also uses a variable 508 named “CountUsers”. Variable 508 may be referred to as “QueryInactiveUsers::CountUsers” 510 to distinguish it from the “QueryActiveUsers::CountUsers” variable and stored in variables area 514. Alternatively, a namespace may not be associated with a container at all. A namespace may be associated with a function or with any kind of grouping.

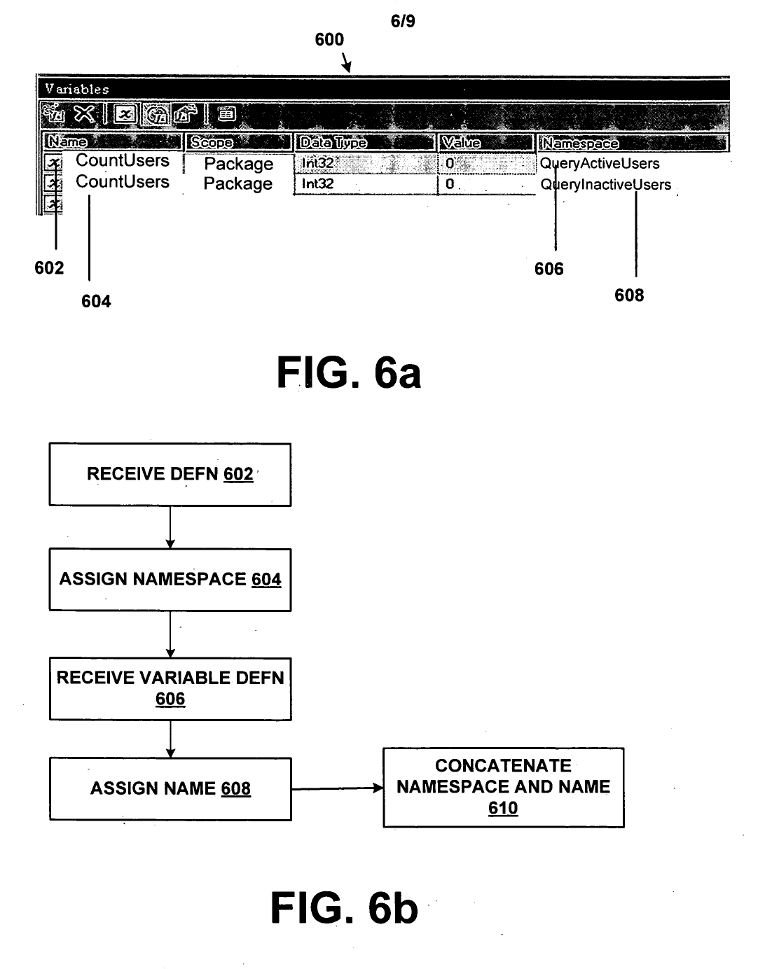

FIG. 6a illustrates an exemplary display 600 in which the above is conveyed. Line 1 602 represents the namespace information (element 606) for variable 502 and line 2 604 represents the namespace information (element 608) for variable 508.

FIG. 6b illustrates an exemplary method for generating namespace variables in accordance with some embodiments of the invention. One or more of the steps illustrated in FIG. 6b may be optional. At step 602 a group definition may be received. At step 604 a namespace may be assigned. In some embodiments of the invention, the namespace name is indicative of a function. At step 606, a variable definition for a variable in the container is defined. At step 608, the variable is assigned a name that is unique for the variable in that container. At step 610, a namespace variable name is generated by concatenating the namespace name for the container with the variable name. The namespace-differentiated variable may be stored in a variables area.

Scoping of Variables

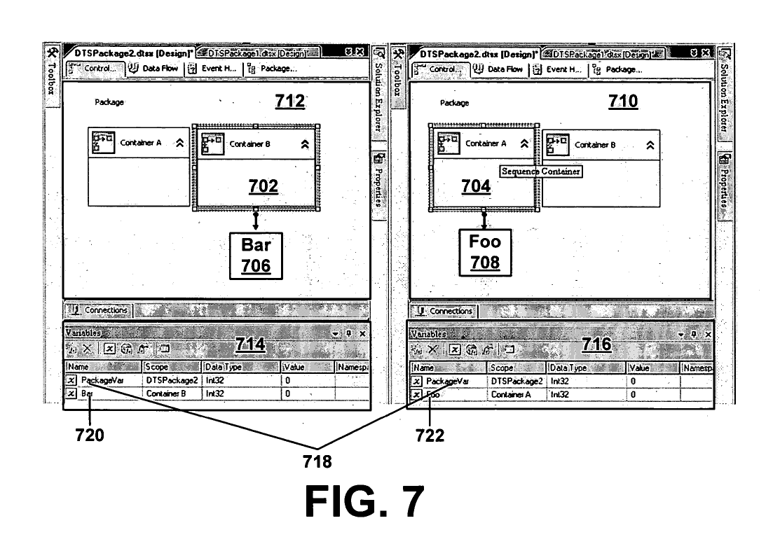

In some embodiments of the invention, a scoping feature enables variables created on one object to be invisible to another object. FIG. 7 is a block diagram illustrating the scoping of variables in accordance with one embodiment of the invention. In FIG. 7, two windows or display areas are illustrated. In one display area, window 710, a container A 704 is associated with a variable called Foo 708. In a second display area, window 712, a container B 702 is associated with a variable called Bar 706. The variable Foo 708 may not be visible to (and not read/write accessible to) container B 702. Similarly the variable Bar 706 may not be visible to (and not read/write accessible to) container A 704.

The scoped nature of the variables is indicated by the variable list displays 714 and 716 in FIG. 7. In variable list display 714 for window 712, system variables (PackageVar 718) and container B 702 variables (variable Bar 720) are listed while in variable list display 716 for window 710, system variables (PackageVar 718) and container A 704 variables (variable Foo 722) are listed.

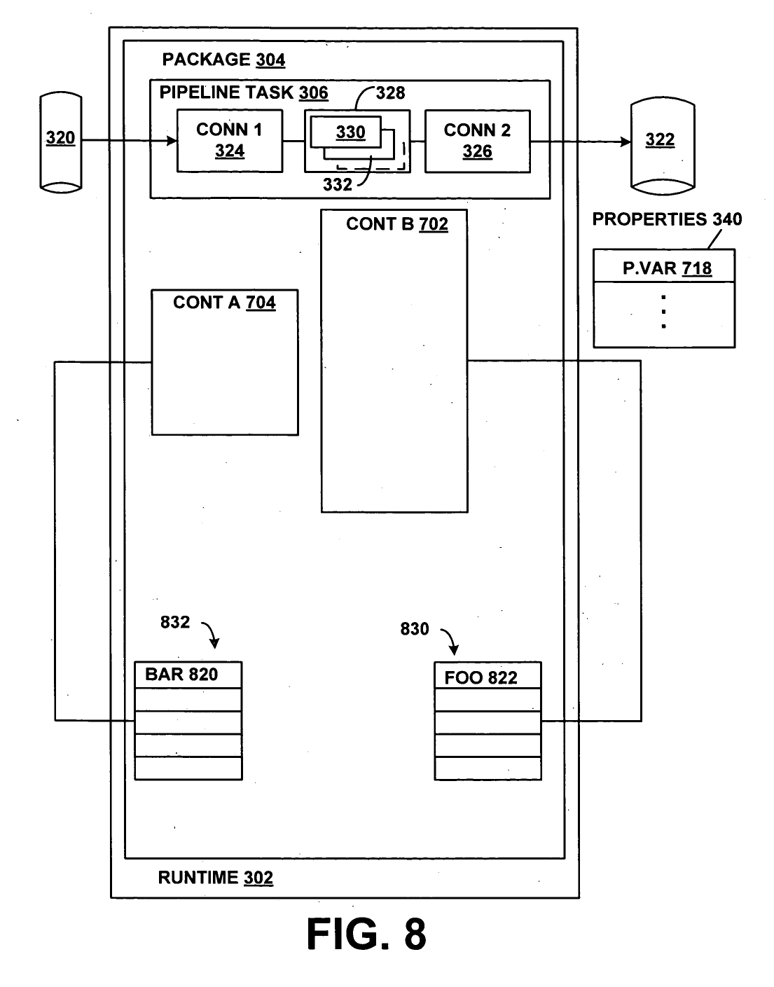

FIG. 8 is a block diagram of a system for scoping variables in accordance with some embodiments of the invention and may contain any of the components described above with respect to FIG. 5. In FIG. 8, a separate variables collection may be maintained for each container. For example collection 830 may be created for container B 702 (containing Foo 822) while a separate variables collection 832 may be created for container A 704 for Bar 820. In some embodiments of the invention the separate variables collection may be implemented as a call stack which is reset as the object is exited.

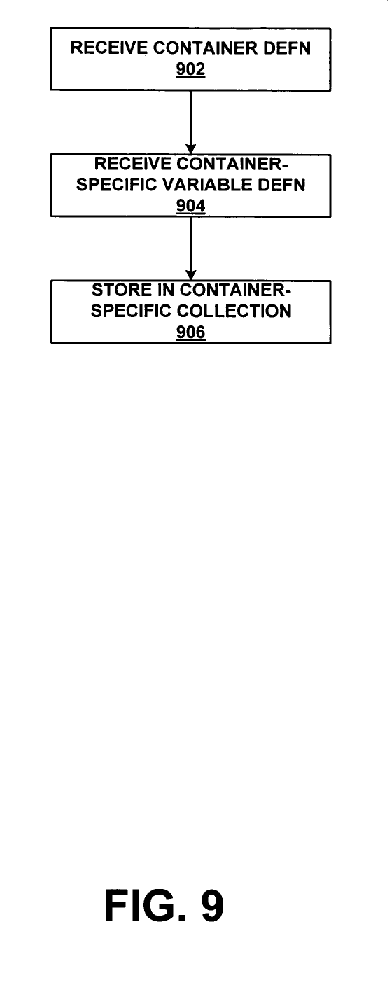

FIG. 9 is an exemplary flow diagram for scoping variables in accordance with some embodiments of the invention. At step 902 a container may be defined. At step 904 a container-specific variable collection space may be allocated. A container-specific variable definition may be received. At step 906 a container-specific variable may be placed in the variable collection space. In some embodiments of the invention, displays of variables are filtered so that only system variable objects and container-specific variables are visible from the container.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed is:

1. A system for differentiating variables in an object model comprising:
an execution environment that associates a first variable with a first namespace in the object model, the first variable thereby differentiated from a second variable in a second namespace.

2. The system of claim 1, wherein the object model comprises a data transformation system.

3. The system of claim 1, wherein the object model comprises a container, the container comprising a subsection of the object model.

4. The system of claim 1, wherein the object model is associated with a function and the first namespace is associated with the function.

5. The system of claim 1, wherein a plurality of variables are grouped by associating the plurality of variables with the first namespace.

6. The system of claim 1, wherein a name of the first variable and a name of the second variable are identical.

7. The system of claim 1, wherein the object model comprises a first function and a second function, the first function associated with the first namespace and the second function associated with the second namespace.

8. The system of claim 1, wherein an identifier for the first variable comprises the first namespace and a name of the first variable.

9. The system of claim 1, wherein the object model comprises a first container and a second container and the first variable is associated with the first container and the second variable is associated with the second container, wherein the first variable is inaccessible to the second container.

10. The system of claim 9, wherein the second variable is inaccessible to the first container.

11. The system of claim 1, wherein the first namespace is associated with a component that uses the first variable.

12. The system of claim 1, wherein a name of the first variable reflects a use of the first variable.

13. A method for differentiating a first variable from a second variable in an object model, the object model comprising a first component, the method comprising:
associating a namespace with the first component, the first component associated with the first variable, the first variable associated with a first variable name;
combining the namespace with the first variable name to generate a unique identifier for the first variable.

14. The method of claim 13, further comprising receiving a definition of the first component in the object model.

15. The method of claim 13, further comprising receiving a definition of the first variable in the object model.

16. The method of claim 13, wherein the first variable name and a name associated with the second variable are identical.

17. The method of claim 13, wherein an identifier for the namespace reflects a function of the first component.

18. The method of claim 13, wherein the first variable name reflects a use of the first variable.

19. A computer-readable medium comprising computer-executable instructions for:
associating a namespace with a first component, the first component associated with a first variable, the first variable associated with a first variable name;
combining the namespace with the first variable name to generate a unique identifier for the first variable.

20. The computer-readable medium of claim 19, comprising further computer-executable instructions for:
receiving a definition of the first component in the object model.

21. The computer-readable medium of claim 19, comprising further computer-executable instructions for:
receiving a definition of the first variable in the object model.

22. A system for scoping variables comprising:
an execution environment that executes an object model comprising a first container and a second container, the execution environment associating a first variable with the first container, the first variable inaccessible to the second container.

23. The system of claim 22, wherein a storage area for storing the first variable comprises a call stack.

24. The system of claim 23, wherein the call stack is reset when the first container is exited.

25. The system of claim 22, wherein the execution environment comprises a data transformation system.

26. A method for making a first variable associated with a first subsection of an object model inaccessible to a second subsection of the object model, comprising:
receiving a definition for the first subsection of the object model, the first subsection definition comprising a first variable definition for the first variable;
storing the first variable in a location inaccessible to the second subsection of the object model.

27. The method of claim 26, further comprising storing the first variable in a call stack.

28. The method of claim 27, further comprising resetting the call stack when the first subsection exits.

29. The method of claim 26, further comprising receiving a second subsection definition, the second subsection definition defining a second variable, wherein the second variable is inaccessible to the first subsection.

30. A computer-readable medium comprising computer-executable instructions for:
receiving a definition for a first subsection, the first subsection definition comprising a first variable definition for a first variable;
storing the first variable in a location inaccessible to a second subsection of the object model.

31. The computer-readable medium of claim 30, comprising further computer-executable instructions for:
storing the first variable in a call stack.

32. The computer-readable medium of claim 31, comprising further computer-executable instructions for:
resetting the call stack when the first subsection exits.
